(19) United States
(12) Patent Application Publication
(10) Pub. No.: US 2011/0068748 A1
(43) Pub. Date: Mar. 24, 2011

(54) Battery Power Routing Circuit

(75) Inventor: Stephen E. Osmialowski, Elyria, OH (US)

(73) Assignee: EVEREADY BATTERY COMPANY, INC., St. Louis, MO (US)

(21) Appl. No.: 12/955,281

(22) Filed: Nov. 29, 2010

Related U.S. Application Data
(63) Continuation of application No. PCT/US2008/065305, filed on May 30, 2008.

(51) Int. Cl. H02J 7/00; H01R 33/00

(52) U.S. Cl. 320/137; 439/627; 439/500

(57) ABSTRACT

A battery power routing circuit includes a first battery contact block with first positive battery electrical contact and a first negative battery electrical contact, and a second battery contact block, with a second positive battery electrical contact and a second negative battery electrical contact. A positive terminal is in electrical communication with the first and second positive battery electrical contacts, and a negative terminal is in electrical communication with the first and second battery negative electrical contacts.

### TECHNICAL FIELD

The following generally relates to battery power routing circuitry, and finds application to battery powered devices, including battery chargers and lighting devices.

### BACKGROUND

Batteries come in a variety of chemistries, sizes, capacities, voltages, and shapes. Often, an electrical device that receives power therefrom and/or supplies power thereto includes a battery-receiving region configured to accept one or more batteries of a particular size. In some instance, the one or more batteries can interchangeably be a set of primary (disposable) or secondary (rechargeable) batteries. Battery chargers generally should only receive secondary batteries.

The battery-receiving region generally includes one or more electrical contacts for electrical communication with the positive terminals of the one or more batteries and one or more electrical contacts for electrical communication with the negative terminals of the one or more batteries. Incorrectly inserting a battery (when possible) in the battery-receiving region such that the positive and negative terminals of the battery respectively contact the negative and positive electrical contacts of the battery-receiving region often results in a non-functional device, as the energy stored in the battery cannot be supplied to the electrical components of the device.

With a battery charger, incorrectly inserting a rechargeable battery as such (when possible) often results in the inability to charge the battery, unless the battery is removed and repositioned in accordance with the correct orientation. Some battery chargers can sense the orientation or polarity of an inserted battery by sensing the polarity of the terminal in communication with either or both of the electrical contacts of the battery charger and, if needed, switch the polarity of the electrical contacts to accommodate the battery orientation. However, this requires polarity sensing and switching circuitry, which may add cost and/or complexity to the battery charger and requires space, which may increase the overall footprint of the device.

### SUMMARY

Aspects of the present application address these matters, and others.

According to one aspect, a battery power routing circuit includes a first battery contact block, with first positive battery electrical contact and a first negative battery electrical contact, and a second battery contact block, with a second positive battery electrical contact and a second negative battery electrical contact. A positive terminal is in electrical communication with the first and second positive battery electrical contacts, and a negative terminal is in electrical communication with the first and second negative battery electrical contacts.

According to another aspect, a battery charger includes a battery receiving bay adapted to receive a battery to be charged, the battery having a positive terminal and a negative terminal located on opposing ends. A first contact block is positioned on a first side of the bay and is configured to alternately receive the positive terminal and the negative terminal. A second contact block is positioned on a second opposing side of the bay and is configured to receive the other of the positive terminal and the negative terminal. Charging power is routed to the battery through the first and second contact blocks.

According to another aspect, an electrical device includes battery receiving contacts arranged with respect to each other such that a battery inserts therebetween independent of a polarity of a battery terminal that physically and electrically engages the battery receiving contacts.

Those skilled in the art will recognize still other aspects of the present invention upon reading and understanding the attached description.

### BRIEF DESCRIPTION OF THE DRAWINGS

The present invention is illustrated by way of example and not limitation in the figures of the accompanying drawings, in which like references indicate similar elements and in which:

FIG. 1 illustrates example battery power routing circuitry;

FIG. 2 depicts a block diagram illustration of a non-limiting embodiment of the battery power routing circuitry;

FIGS. 3A, 3B and 3C illustrate various views of a non-limiting embodiment of the battery power routing circuitry;

FIGS. 4A, 4B and 4C show an example lighting device in which the contact block of FIG. 3 can be employed;

FIG. 5 depicts a block diagram illustration of a non-limiting embodiment in which the battery power routing circuitry is configured to receive a plurality of batteries in a parallel configuration;

FIGS. 6A and 6B show another non-limiting embodiment of a contact block of the battery power routing circuitry;

FIGS. 7A and 7B show an example electrical device which includes the battery power routing circuitry;

FIGS. 8A and 8B show an example battery charger which includes a multi, single-battery bay embodiment of the battery power routing circuitry;

FIG. 9 depicts a block diagram illustration of a non-limiting embodiment in which the battery power routing circuitry is configured to receive two batteries in a series configuration; and

FIG. 10 depicts a block diagram illustration of a non-limiting embodiment in which the battery power routing circuitry is configured to receive four batteries in a series configuration.

### DETAILED DESCRIPTION

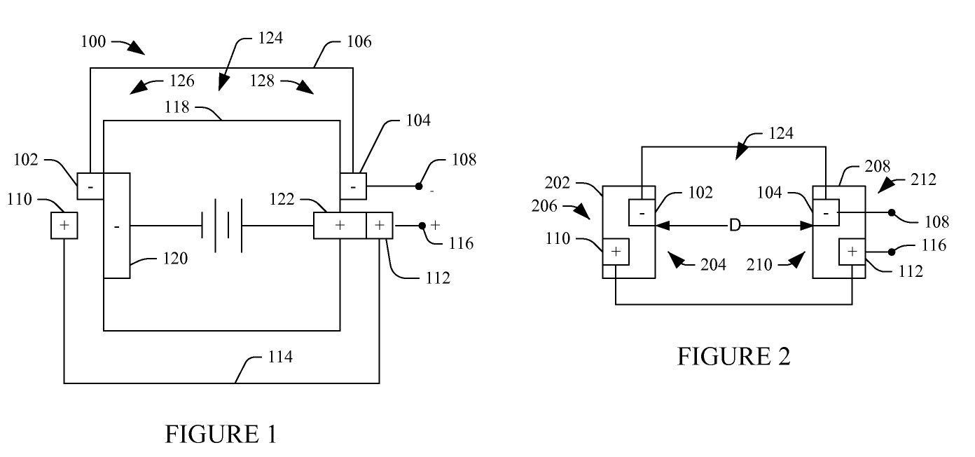

FIG. 1 illustrates example battery power routing circuitry 100 (a battery power routing circuit), which can be used in essentially any electrical device configured to receive at least one elongate battery, having positive and negative terminals at opposing ends along a longitudinal direction, for supplying and/or receiving power. As described in greater detail below, the battery power routing circuitry 100 can receive a battery independent of battery terminal polarity in that the set of electrical contacts that electrically communicate with the battery is adapted to interchangeably or reversibly receive both the positive and the negative terminals of the battery. As a consequence, the battery 102 cannot be installed incorrectly in reverse polarity, and polarity sensing circuitry can be omitted.

In the illustrated example, the battery power routing circuitry 100 includes first and second negative electrical contacts 102, 104, electrically coupled together via a path 106 and both in electrical communication with a negative terminal 108. The battery power routing circuitry 100 further includes first and second positive electrical contacts 110, 112, electrically coupled together via a path 114 and both in electrical communication with a positive terminal 116.

The electrical contacts 102, 104, 110, 112 are arranged with respect to each other so that when a battery 118 is inserted therebetween, independent of the polarity of the terminals, one of the negative electrical contacts 102, 104 electrically communicates with a negative terminal 120 of the battery 118 and one of the positive electrical contacts 110, 112 electrical communicates with a positive terminal 122 of the battery 118. In one instance, the arrangement of the electrical contacts 102, 104, 110, 112 defines a battery receiving region 124 between the electrical contacts 102, 110 and the electrical contacts 104, 112, with the electrical contacts 102, 110 being on a first side 126 of the battery receiving region 124 and the electrical contacts 104, 112 being on a second side 128 of the battery receiving region 124.

On the first side 126, the electrical contacts 102, 110 are configured with respect to each other such that the positive electrical contact 110 is offset away from the battery receiving region 124 in the longitudinal direction relative to the negative electrical contact 102, with the negative electrical contact 102 positioned to electrically communicate with the negative terminal 120 of the battery 118 when the battery 118 is inserted with the negative terminal 120 facing the negative electrical contact 102, and with the positive electrical contact 110 positioned to electrically communicate with the positive terminal 122 of the battery 118 when the battery 118 is inserted with the positive terminal 122 facing the positive electrical contact 110.

Likewise, on the second side 128, the electrical contacts 104, 112 are configured with respect to each other such that the positive electrical contact 112 is offset away from the battery receiving region 124 in the longitudinal direction relative to the negative electrical contact 104, with the negative electrical contact 104 positioned to electrically communicate with the negative terminal 120 of the battery 118 when the battery 118 is inserted with the negative terminal 120 facing the negative electrical contact 104, and with the positive electrical contact 112 positioned to electrically communicate with the positive terminal 122 of the battery 118 when the battery 118 is inserted with the positive terminal 122 facing the positive electrical contact 112.

One result of the above is that the battery 118 can be interchangeably inserted in the battery receiving region 124 in that the positive terminal 120 (and the negative terminal 122) of the battery 118 can face either the electrical contacts 102, 110 or the electrical contacts 104, 112.

FIG. 2 depicts a block diagram illustration of a non-limiting embodiment of the battery power routing circuitry 100, absent the battery 118. With this embodiment, a first contact support 202, with an inner side 204 facing toward the battery receiving region 124 and an outer side 206 facing away from the battery receiving region 124, physically supports the electrical contacts 102, 110, and a second contact support 208, with an inner side 210 and an outer side 212, physically supports the electrical contacts 104, 112. As shown, the contact supports 202, 208 are separated from each other by a distance “D,” which, in this example, is about equal to the length of the battery 118. In this example, the contact supports 202, 208 are stationarily affixed as such, with the distance “D” configured so that the battery receiving region 124 receives a particular size battery (e.g, AA, AAA, C, D, etc.) or batteries (e.g., AA and AAA). As described in greater detail below, alternatively at least one of the contact supports 202, 208 may be moveably affixed such that it can move in the longitudinal direction.

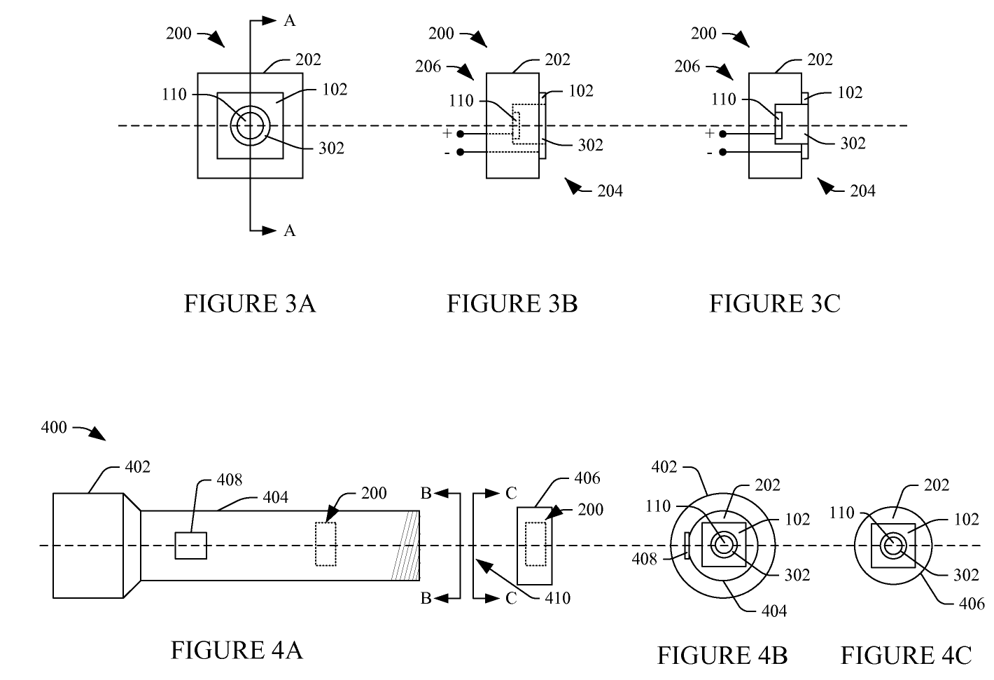

FIGS. 3A, 3B and 3C illustrate various views of a non-limiting embodiment of a contact block 200 of the battery power routing circuitry 100. For sake of brevity, only one of two contact blocks 200 is discussed below. However, it is to be understood that the other contact block 200 is substantially similar. FIG. 3A illustrates a view facing the inner side 204 of the support structure 202. For explanatory purposes, the support structure 202 and the negative electrical contact 102 are square shaped and the positive electrical contact 110 is circular shaped; however, other shapes are also contemplated herein. In addition, in FIG. 3A the positive electrical contact 110 is shown as being within a perimeter defined by the negative electrical contact 102, with a material 302 lying therebetween. Collectively, the support structure 202, the electrical contacts 102, 110, and the material 302 are referred to herein as the contact block 200.

From FIG. 3B, which is a side view of the support structure 202, in this embodiment the negative electrical contact 102 resides on a surface of the inner side 204, with its width being emphasized or pronounced in FIG. 3B for sake of clarity. The positive electrical contact 110, as briefly discussed above, is recessed or offset away from the side 204 (and the battery receiving region 124) relative to the negative electrical contact 102. In this example, the positive electrical contact 110 is offset from the negative electrical contact 102 by a distance slightly greater than the length of the positive terminal 124. As such, when the battery 118 is inserted such that the positive terminal 124 faces the side 204, the positive terminal 124 extends into the recess and contacts the positive electrical contact 110. The material 302, in this example, extends from the negative electrical contact 102 to the positive electrical contact 110. The material 302 include a non-conductive material and provides a non-conductive barrier between the negative and positive electrical contacts 102, 110. The above is also shown in FIG. 3C, which illustrates a cross-sectional view along line A-A of FIG. 3A.

With reference to FIGS. 3A, 3B and 3C, the surfaces of the negative and positive electrical contacts 102, 110 facing the battery receiving region 124 are respectively dimensioned in accordance with the dimensions of the negative and positive terminals 120, 122 of the battery 118. In one instance, the dimensions of the surface of the negative and positive electrical contacts 102, 110 maximize electrical contact respectively with the negative and positive terminals 120, 122 of the battery 118. For example, in one instance the diameter of the positive electrical contact 110 is about the same size as the diameter of the positive terminal 122 of the battery 118, thereby optimizing surface area contact therebetween. Of course, in other embodiments the diameter of the electrical contacts 102, 110 may be larger or smaller than the diameter of the terminals 120, 122.

FIGS. 4A, 4B and 4C show an example electrical device 400 in which the contact block 200 of FIG. 3 can be employed. Initially referring to FIG. 4A, the illustrated electrical device 400 is a lighting device such as a flashlight, which is powered by the battery 118. The flashlight 400 includes a head portion 402, a body portion 404 and an end portion 406. The head portion 402 defines a cavity which encloses a light source (not visible), an optional a light reflector (not visible) and/or other components. A switch 408 opens and closes a circuit that supplies battery power to the light source. The body portion 404 includes a battery receiving region 410 that extends longitudinally between the head portion 402 and the end portion 406. In this example, the battery receiving region 410 is configured to receive a single battery 118. In other embodiments, the battery receiving region 410 can receive more than one of the batteries 118. The end portion 406 removeably fastens to the body portion 404. The battery 118 can be inserted into and removed from the battery receiving region 410 by removing the end portion 406 from the body portion 404.

FIG. 4B shows a cross-section view looking into the battery receiving region 410 from line B-B of FIG. 4A. In the illustrated example, the contact block 200 is affixed within the battery receiving region 410 with the inner side 204 facing the end portion 406. As discussed above, the contact block 200 can receive either the positive or the negative terminal 122, 120. FIG. 4C shows a cross-section view looking into the end portion 406 from line C-C of FIG. 4A. The contact block 200 is affixed within the end portion 406 with the inner side 204 facing the head portion 404. The contact block 200 in the end portion 406, when the end portion 404 is fastened to the body 404, electrically contacts the other of the positive or the negative terminal 122, 120. Fastening the end portion 406 to the body 404, after inserting the battery 118 into the battery receiving region 410, holds the battery terminals 120, 122 in electrical communication with the electrical contacts 102, 110.

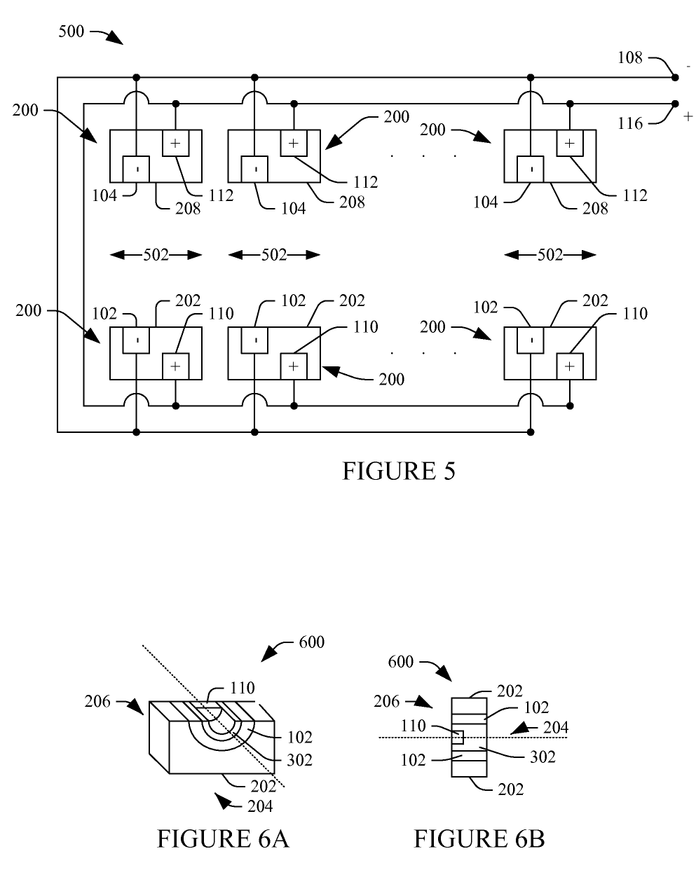

FIG. 5 depicts a block diagram illustration of a non-limiting embodiment 500 in which the battery power routing circuitry 100 is configured to receive a plurality of batteries. In this example, each of a plurality of pairs of the contact blocks 200 defines a bay 502 for a single battery 118. The pairs of contacts blocks 202 are electrically coupled together in parallel so that the positive electrical contacts 110, 112 are all in electrical communication with the positive terminal 116, and the negative electrical contacts 102, 104 are all in electrical communication with the negative terminal 108. As such, regardless how the batteries are inserted into each of the bays 502, the positive terminals 122 of the battery 118 are electrically coupled together and the negative terminals 120 of the battery 118 are electrically coupled together. Note that the positive terminals 122 and the negative terminals 120 are connected as such even if one or more of the bays 502 does not receive one of the batteries 118. Although, this may be necessary for proper operation of the device employing the embodiment 500. In another embodiment, the contact blocks 200 are connected in series.

FIGS. 6A and 6B show an alternate contact block 600. FIG. 6A shows a perspective view of the contact block 600, and FIG. 6B show a top view. Similar to the contact block 200, the contact block 600 includes the support structure 202, the negative electrical contact 102, the positive electrical contact 110, and the non-conductive material 302. With this embodiment, however, the negative electrical contact 102 is circular shaped and extends through the contact block 600 from the inner side 204 to the outer side 206. In addition, whereas the contact block 200 surrounds the positive terminal 122 when the battery 118 is inserted with the positive terminal 122 facing the side 204, the contact block 600 provides an open configuration in which the contact block 600 only surrounds half of the positive terminal 122 when the battery 118 is inserted as such. Other shapes and configurations are also contemplated.

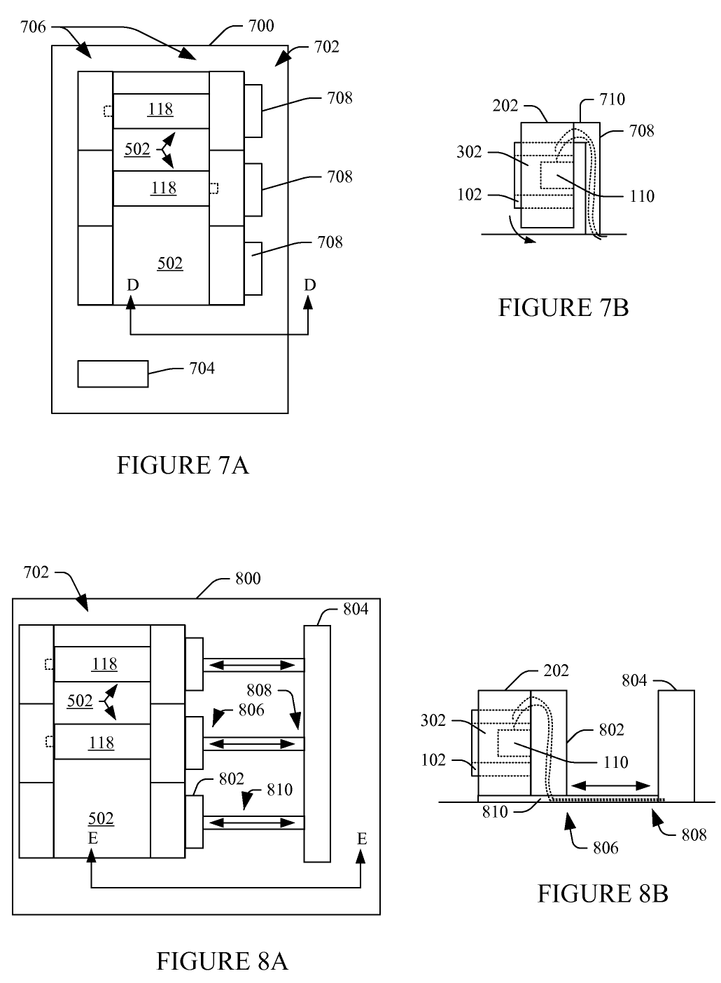

FIGS. 7A and 7B show an example electrical device 700 which includes the battery power routing circuitry 100 and, in particular a multi, single-battery bay embodiment 702 of the battery power routing circuitry 100. As shown, two batteries 118 are installed in the three bays 502. Note that the batteries 118 are installed in opposing orientations. The batteries 118 installed therein are used to supply power to at least one electrical component 704 of the electrical device 700. In the illustrated embodiment 702, each of the bays 502 is defined by a space between two contact blocks 706, each including the support structure 202, positive and negative electrical contacts 122, 120, and the non-conductive material 302, similar to the contact blocks 200 and 600. It is to be appreciated that in other embodiments the contact blocks 706 can be the contact block 200, the contact block 600, or another contact block. In this illustrated configuration, at least one of each pair of the contact blocks 706 is affixed to a member 708.

As shown in FIG. 7B, the member 708 includes a protrusion 710, which protrudes from the member 708 in a direction towards the battery receiving region 124. Each of the contact blocks 706 is affixed to one of the protrusions 710. Each of the members 708 is flexible and can flexure in a direction toward the battery receiving region 124, thereby allowing each contact blocks 706 to pivot about a corresponding protrusion 710, away from the battery receiving region 124. In one instance, the contact block 706 is urged away from the battery receiving region 124 when inserting the battery 118 into the bay 502. For example, the end of the battery 118 can be used to urge the contact block 706 as such. Once the battery 118 is inserted therein, the member 708 returns to a non-flexure position, engaging the battery 118 between the contact blocks 706. The contact block 706 can be similarly moved when removing the battery 118 from a bay 502.

FIGS. 8A and 8B show an example battery charger 800 which includes the battery power routing circuitry 100 and, in particular, the multi, single-battery bay embodiment 702 described in connection with FIGS. 7A and 7B. However, instead of the being affixed to the protrusion 710 of the member 708, at least one of each pair of the contact blocks 706 is affixed to a member 802. The member 802 is slidably affixed to the charger 800 so as to slide, relative to a fixed member 804, between a first retracted position 806 at which the contact block 706 is relatively nearer its pair contact block 706 and a second extended position 808 at which the contact block 706 is relatively farther away from its pair contact block 706.

In the illustrated embodiment, the member 802 may slide along a track 810. In other embodiments, other sliding mechanisms can be employed. For example, the member 802 may be slidably mounted within a slot, coupled to a linear bearing, etc. In one instance, this allows the first and second contact supports 202, 204 to be separated for insertion and/or removal of the battery 118. A spring or other device may be connected to the member 802 so as to urge the member 802 towards the battery receiving region 124. The charger 800 may also include a mechanism that facilitates separating the contact blocks 706 for battery insertion and/or removal.

It is to be appreciated that the battery charger 800 includes a body and a cover. In one embodiment, the cover is mounted for pivotal motion relative to the body about a pivot or hinge. When in an open position, one or more of the batteries 118 can be removed from and/or installed in the bays 502. In one instance, the contacts blocks 802 are in operative mechanical communication with the cover so that when the cover moves to the open position, the contact blocks 802 move to the extended position 808 and the spacing between the pair of contact blocks 802 is greater than the longitudinal dimension of the battery 118 being removed from and/or installed in the battery charger 800.

As a consequence, one of the batteries 118 can be inserted in one of the bays 502 without overcoming the contact force. When the cover is in the closed position, the spacing between the contact blocks 802 is such that the contact blocks 802 make electrical contact with the terminals 120, 122 of the battery(s) 118 received in the respective bays 502. A power cord connects the battery charger 800 to a suitable power source, for example a wall cube which can be plugged into a standard alternating current (AC) power receptacle. A switch or the like activates charging of the batteries 118 inserted into the charger 800.

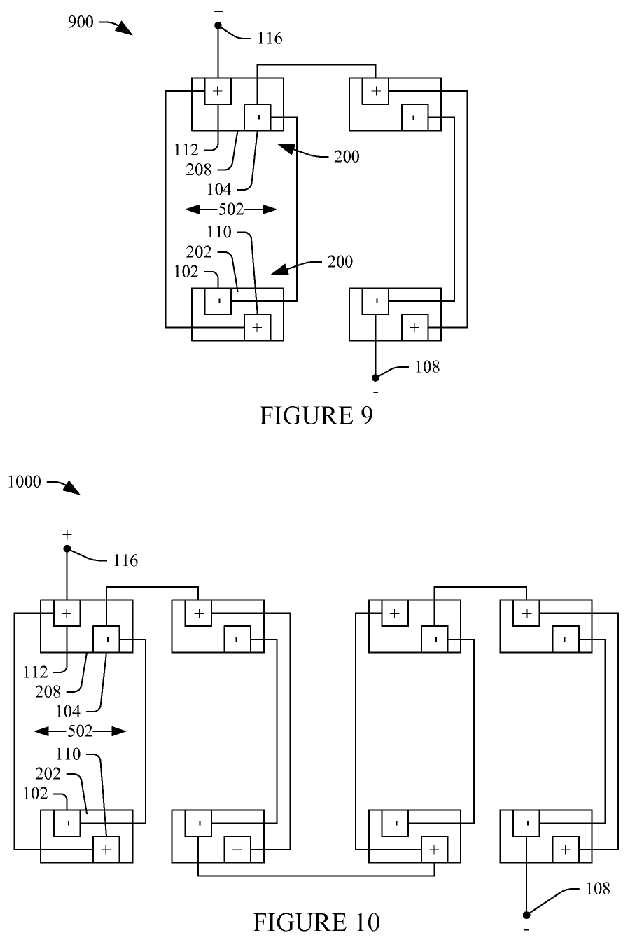

FIGS. 9 and 10 depict block diagram illustrations of non-limiting embodiments in which the battery power routing circuitry 100 is configured to receive a plurality of batteries. In FIG. 5 above, each of the plurality of pairs of the contact blocks 200 were electrically coupled together in parallel. In FIGS. 9 and 10, each of the plurality of pairs of the contact blocks 200 are electrically coupled together in series. FIG. 9 shows a two bay configuration, and FIG. 10 shows a four bay configuration. Of course, embodiments with N bays, wherein N is a positive integer, including three bays and more than four bays are contemplated herein. As discussed above, each of the plurality of pairs of the contact blocks 200 defines a bay 502 for a single battery 118. As shown, regardless of how the batteries are inserted into each of the bays 502, the batteries are always correctly inserted with respect to polarity since the contact blocks 202 are polarity independent.

Although different configurations of the battery power routing circuitry 100 were described in connection with particular electrical devices, it is to be appreciated that the different configurations and variations thereof can be employed with electrical devices described herein as well as other electrical devices.

The invention has been described with reference to the preferred embodiments. Of course, modifications and alterations will occur to others upon reading and understanding the preceding description. It is intended that the invention be construed as including all such modifications and alterations insofar as they come within the scope of the appended claims.

What is claimed is:

1. A battery power routing circuit, comprising:
a first battery contact block, including
a first positive battery contact having a circular shape and a flat surface;
a first negative battery contact having a rectangular shape;
a non-conductive material between the first positive battery contact and the first negative battery contact; and
the first positive battery contact being within a perimeter of the first negative battery contact and being offset a longitudinal distance from the first negative battery contact;
a second battery contact block, including
a second positive battery contact; and
a second negative battery contact;
a positive terminal in electrical communication with the first and second positive battery contacts; and
a negative terminal in electrical communication with the first and second negative battery contacts.

2. The battery power routing circuit of claim 1, the first and second battery contact blocks are arranged with respect to each other such that a battery inserts therebetween independent of a polarity of the terminal that physically and electrically engages the first or the second battery contact block.

3. The battery power routing circuit of claim 1, the longitudinal distance being slightly greater than a length of a positive terminal of a battery inserted between the first and second battery contact blocks.

4. The battery power routing circuit of claim 1, further including:
a third battery contact block, including
a third positive battery contact; and
a third negative battery contact;
a fourth battery contact block, including
a fourth positive battery electrical contact; and
a fourth negative battery electrical contact.

5. The battery power routing circuit of claim 4, further comprising a second positive terminal in electrical connection with the third and fourth positive battery contacts and a second negative terminal in electrical connection with the third and fourth negative battery contacts.

6. The battery power routing circuit of claim 5, the second positive terminal in electrical connection with the positive terminal and the second negative terminal in electrical connection with the negative terminal.

7. The battery power routing circuit of claim 5, the second positive terminal in electrical connection with the negative terminal and the second negative terminal in electrical connection with the positive terminal.

8. The battery power routing circuit of claim 1, wherein at least one of the first and second battery contact blocks is configured to move relative to the other of the first and second battery contacts blocks.

9. The battery power routing circuit of claim 1, wherein at least one of the first and second battery contacts blocks slides to a first position to increase the distance between the first and second battery contacts blocks so that a battery is inserted between the battery contact blocks with substantially zero insertion force.

10. The battery power routing circuit of claim 1, further comprising a routing circuit to connect the positive and negative battery terminals to an electrical component of a battery powered electrical device.

11. The battery power routing circuit of claim 1, the positive and negative terminals are connected to a light source.

12. The battery power routing circuit of claim 1, charging power from an alternating current power source is supplied to the positive and negative terminals.

13. A battery power routing circuit, comprising:
a first battery contact block, including
a first positive battery contact having a circular shape and a flat surface;
a first negative battery contact having a circular shape;
a non-conductive material between the first positive battery contact and the first negative battery contact; and
the first positive battery contact being within a perimeter of the first negative battery contact and being offset a longitudinal distance from the first negative battery contact;
a second battery contact block, including
a second positive battery contact; and
a second negative battery contact;
a positive terminal in electrical communication with the first and second positive battery contacts; and
a negative terminal in electrical communication with the first and second negative battery contacts.
